(19) United States
(12) Patent Application Publication
(10) Pub. No.: US 2006/0023229 A1
(43) Pub. Date: Feb. 2, 2006

(54) Camera module for an optical inspection system and related method of use

(76) Inventors: Cory Watkins, Eden Prairie, MN (US); David Vaughnn, Edina, MN (US); Pat Simpkins, Edina, MN (US)

Correspondence Address: DICKE BILLIG & CZAJA, PLLC;ATTN: CHRISTOPHER MCLAUGHLIN, 100 SOUTH FIFTH STREET, SUITE 2250, MINNEAPOLIS, MN, 55402, US

(21) Appl. No.: 11/179,019

(22) Filed: Jul. 11, 2005

Related U.S. Application Data
(60) Provisional application No. 60/587,116, filed on Jul. 12, 2004.

(51) Int. Cl. G01B 11/24

(52) U.S. Cl. 356/601

(57) ABSTRACT

Aspects of the present invention relate to a camera module for use in an optical inspection system. The camera module includes a beamsplitter assembly, a first detector assembly, and a second detector assembly. The beamsplitter assembly defines orthogonally arranged first and second sides that are optically separated by a beamsplitter face. The first detector assembly includes a detector array for sensing an image. The first detector assembly is associated with the first side of the beamsplitter assembly. The second detector assembly similarly includes a detector array for sensing an image. The second detector assembly is associated with the second side of the beamsplitter. Further, the first and second detector assemblies are substantially optically aligned relative to the beamsplitter assembly.

### CROSS-REFERENCE TO RELATED APPLICATIONS

This subject matter of this application is related to the subject matter of U.S. Provisional Patent Application No. 60/587,116, filed Jul. 12, 2004 and entitled “Dual Chip Camera” (Attorney Docket No. A126.176.101), priority which is claimed under 35 U.S.C. §119(e) and the entirety of which is incorporated herein by reference.

### BACKGROUND OF THE INVENTION

Aspects of the present invention relate to optical inspection systems. More particularly, aspects of the present invention relate to a camera module, an optical inspection system utilizing the camera module, and methods for use thereof.

Semiconductor and/or microelectronic component manufacturers have a marked need to inspect products at various stages of manufacture. The merit in inspecting microelectronics and semiconductors throughout the manufacturing process is obvious in that identified, “bad” components/wafers may be removed at the various processing stages rather than manufacturing to completion only to recognize that a defect exists either by end inspection or by failure during use. Many techniques have been developed to perform such inspections, ranging from manual to automated. To this end, reliable and rapid, yet relatively inexpensive, automated inspection equipment is highly desirable.

Many of the currently available microelectronic and semiconductor inspections systems and methods are insufficient for a variety of reasons including lack of speed, accuracy, clarity, and the like. More recently, a distinct advantage has been realized by optical inspection systems utilizing a camera. While highly viable, camera-based optical inspection systems may have certain speed of inspection limitations due to the time it takes for a camera to acquire and integrate an image. One approach for reducing the rate of inspection bottleneck is to employ a large format camera; unfortunately, however, large format cameras have limited read-out rates and have not kept pace with the need for faster inspection. Alternatively, optical inspection systems have been developed employing two discrete cameras connected by an optical mechanical assembly that facilitates movement of the two cameras relative to one another. In order to accurately perform imaging and subsequent inspection, alignment between the two cameras must be present at all times. Further, camera alignment will likely change during any movement of the device, such as during shipping. This, in turn, requires that the operator constantly check for camera misalignment, and manipulate the mechanical assembly to re-align the cameras. This is clearly a time consuming process, and may not consistently achieve necessarily alignment. In addition, inherent differences between the cameras may render their corresponding image outputs incompatible unless these differences are accounted for.

In light of the above, a need exists for a camera-based, optical inspection system capable of rapidly inspecting microelectronic and semiconductor components.

### SUMMARY

Aspects of the present invention relate to a camera module for use in an optical inspection system. The camera module includes a beamsplitter assembly, a first detector assembly, and a second detector assembly. The beamsplitter assembly defines orthogonally arranged, first and second sides that are optically separated by a beamsplitter face. The first detector assembly includes a detector array for sensing an image and is optically associated with the first side of the beamsplitter assembly. The second detector assembly similarly includes a detector array for sensing an image and is optically associated with the second side of the beamsplitter. To this end, the first and second detector assemblies are substantially optically aligned relative to the beamsplitter assembly. In one embodiment, corresponding pixels provided by the detector arrays of the first and second detector assemblies are substantially optically aligned relative to the beamsplitter face in terms of translation and rotation. In another embodiment, the substantial optical alignment relationship is characterized by sub-pixel alignment. In another embodiment, the first and second detector assemblies are permanently assembled to the beamsplitter assembly such that the substantial optical alignment cannot be altered. In yet another embodiment, the detector assemblies each include the detector array and an optical low pass filter.

Other aspects of the present invention relate to an optical inspection system for inspecting a surface of a sample. The system includes a light source, a camera module, and a controller. The light source is provided to illuminate the sample surface. The camera module includes a beamsplitter assembly, a first detector assembly, and a second detector assembly. The beamsplitter assembly defines orthogonally arranged, first and second sides optically separated by a beamsplitter face. The first detector assembly includes a detector array and is optically associated with the first side of the beamsplitter assembly. The second detector assembly also includes a detector array and is optically associated with the second side of the beamsplitter assembly. With this arrangement, the first and second detector assemblies are substantially optically aligned relative to the beamsplitter assembly. The controller is electronically coupled to the camera module. Further, the controller is adapted to process image information signaled by the detector arrays, and to generate an image of at least one site on the sample surface based upon reference to the signaled information from at least the first detector assembly. In one embodiment, the controller is further adapted to perform an inspection routine based upon an image generated by reference to image information signaled from the first detector assembly and upon an image generated by reference to image information signaled from the second detector assembly. In this regard, the images can be of the same sample surface site or from different sites. In another embodiment, the controller is further adapted to correlate signaled information from the second detector assembly with signaled information from the first detector assembly.

Other aspects of the present invention relate to a method of optically inspecting a surface of a sample. The method includes providing a camera module including a beamsplitter assembly, a first detector assembly, and a second detector assembly. The beamsplitter assembly defines orthogonally arranged first and second sides that are optically separated by a beamsplitter face. The first detector assembly includes a detector array and is optically associated with the first side of the beamsplitter assembly. The second detector assembly also includes a detector array for sensing an image, and is optically associated with the second side of the beamsplitter assembly. With this configuration, the first and second detector assemblies are substantially optically aligned with one another relative to the beamsplitter assembly. The camera module is positioned over a site of the sample surface. The surface site is then illuminated, with the camera module receiving light reflected from the surface site. The detector array of the first detector assembly is prompted to generate image information relating to the surface site. The image information from the first detector assembly is processed to generate a site image. A determination is then made as to whether the surface site is acceptable based upon reference to the site image. In one embodiment, the detector arrays of both of the first and second detector assemblies are prompted to generate image information that is used to determine whether a surface site(s) in question is acceptable. For example, the first and second detector assemblies are operated to simultaneously generate image information for the same surface site; alternatively, the first and second detector assemblies are operated to generate image information for different surface sites on an alternative basis. Regardless, in one embodiment, the method is characterized by not mechanically re-positioning the first and second detector assemblies relative to one another prior to performing an inspection.

### BRIEF DESCRIPTION OF THE DRAWINGS

FIG. 1 is a schematic diagram illustrating one embodiment of an optical inspection system in accordance with aspects of the present invention;

FIG. 2 is a side, plan view of a camera module portion of the inspection system of FIG. 1;

FIG. 3 is an enlarged, side plan view of a portion of the camera module of FIG. 2;

FIG. 4 is an enlarged, cross-sectional view of one embodiment of a pin assembly portion of the camera module of FIG. 2;

FIG. 5 is a simplified top, plan view of a semiconductor wafer, illustrating sites to be imaged by the inspection system of FIG. 1;

FIG. 6 is a flow diagram illustrating one embodiment of a method of inspecting a surface of a sample in accordance with aspects of the present invention;

FIG. 7 is a flow diagram illustrating another embodiment of a method of inspecting a surface of a sample in accordance with aspects of the present invention; and

FIG. 8 illustrates intensity and gain charts useful for correlating image information signaled from two detector arrays in accordance with aspects of the present invention.

### DETAILED DESCRIPTION

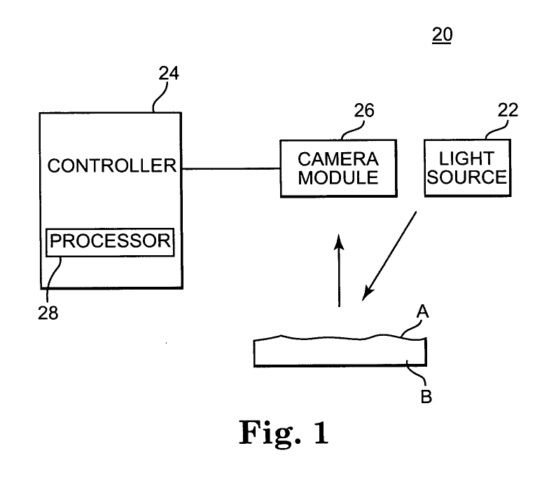

One embodiment of an optical inspection system 20 for optically inspecting a surface A of a sample B is shown in FIG. 1. The inspection system 20 includes a light source 22, a controller 24, and a camera module 26. Details on the various components 22-26 are provided below. In general terms, however, the controller 24 is electronically coupled to the camera module 26 and, in some embodiments, to the light source 22. During use, the light source 22 illuminates the sample surface A, with light reflected from the sample, surface A being received at the camera module 26. Corresponding image information is signaled from the camera module 26 to the controller 24 for subsequent processing, such as defining an image based upon the signaled image information, as well as performing one or more inspection routines. In one embodiment, the optical inspection system 20 is an automated system that is configured to inspect substrates, such as semiconductor wafers and semiconductor die. To this end, and as described in greater detail below, the light source 22 and the controller 24 can assume a wide variety of forms appropriate for performing a desired inspection.

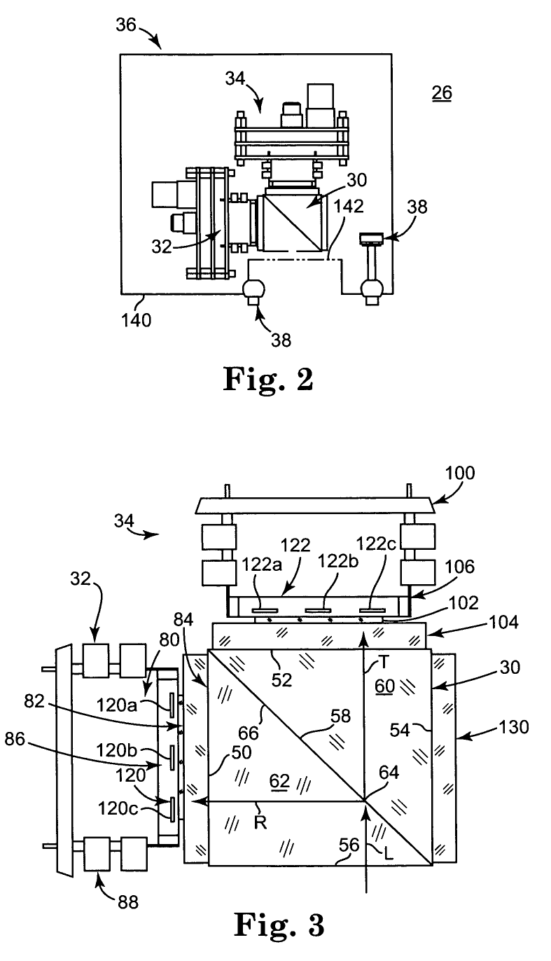

One embodiment of the camera module 26 is shown in greater detail in FIG. 2. In general terms, the camera module 26 includes a beamsplitter assembly 30, a first detector assembly 32, and a second detector assembly 34. In addition, and in some embodiments, the camera module 26 further includes a housing 36 and mounting devices 38, and may, in other embodiments, include additional optical components (not shown), such as one or more lens, etc. In a preferred embodiment, the first and second detector assemblies 32, 34 are permanently mounted to the beamsplitter assembly 30 in a substantially optically aligned relationship, though it is to be understood that in other embodiments the first and second detector assemblies 32, 34 may be removable from the beamsplitter assembly 30. The housing 36 encloses the assemblies 30-34 to impede user access thereto. Finally, the mounting devices 38 are adapted to facilitate mounting and removal of the camera module 26 to and from an inspection system frame (not shown).

The assemblies 30-34 are shown in greater detail in FIG. 3. In one embodiment, the beamsplitter assembly 30 has a cube-like configuration, defining first, second, third, and fourth sides 50-56, and includes a beamsplitter face 58. With this configuration, the first and second sides 50, 52 are orthogonally arranged relative to one another, and are adapted to define an optically transmissive face for a respective one of the detector assemblies 32 or 34. The beamsplitter face 58 is arranged such that light entering the beamsplitter assembly 30 at the fourth side 56 thereof is primarily directed toward the first and second sides 50, 52, and thus is optically positioned between the first and second sides 50, 52. In another embodiment, the beamsplitter assembly 30 may include a beamsplitter mounted within a framework (not shown) that facilitates mounting the first and second detector assemblies 32, 34 to the assembly 30 in a manner similar that illustrated in FIG. 3.

In one embodiment, the beamsplitter assembly 30 includes a first prism 60 and a second prism 62. The prisms 60, 62 are, in one embodiment, right angle prisms, with the first prism 60 defining the second and third sides 52, 54 of the beamsplitter assembly 30 and a second prism 62 defining the first and fourth sides 50, 56. In addition, each of the prisms 60, 62 defines a hypotenuse side 64, 66, respectively. The beamsplitter face 58 is formed on one or both of the hypotenuse sides 64 and/or 66. For example, in one embodiment, the first prism 60 forms the beamsplitter face 58 as a non-polarizing beamsplitter on the hypotenuse side 64. Regardless, the prisms 60, 62 are mounted to one another to define the beamsplitter assembly 30 as shown.

While the beamsplitter assembly 30 has been described as being a cube-type beamsplitter, a wide variety of other beamsplitter configurations are equally acceptable. For example, in an alternative embodiment, the beamsplitter assembly 30 incorporates a pellicle beamsplitter. Alternatively, a micro mechanical device such as a Texas Instrument digital light processing (DLP) mechanism or the like may be used to direct light to a specified detector. Regardless, the beamsplitter assembly 30 is configured to provide at least two sides (e.g., the first and second sides 50, 52) optically separated by a beamsplitter face (e.g., the beamsplitter face 58) and adapted to allow transmission of light to at least two detector assemblies.

The first detector assembly 32 includes, in one embodiment, an image sensor 80 (drawn generally), a cover glass 82, and a spacer 84. In general terms, the cover glass 82 is integrally formed with and encompasses a light inlet side of the image sensor 80, and is mounted to the spacer 84. The spacer 84, in turn, is mounted to the first side 50 of the beamsplitter assembly 30.

The image sensor 80 can assume a variety of forms as is known in the art, and includes a detector array 86 (illustrated schematically) and a frame 88. In addition, the image sensor 80 can include other conventional components, such as one or more outlet ports (not shown) used to electronically couple the image sensor 80 to the controller 24 (FIG. 1) for delivering output signals to the controller 24. In one embodiment, the image sensor 80 is a charge-coupled device (CCD) chip or complementary metal oxide system (CMOS) light sensor such that the detector array 86 comprises an array of pixels. It is intended that the use of the terms “CCD” and “CMOS” are interchangeable with one another to describe light sensors useable as part of the various embodiments of the invention. In particular, the CCD is divided into a number of rows of microscopic pixels. When a photon hits a pixel, a charge builds up in each pixel relative to the number of photons hitting it. The contents of each pixel are read, forming an electrical signal output from the image sensor 80 indicative of a surface being examined by the camera module 26. With this one embodiment, the CCD chip 80 can be adapted for various types of imaging. For example, the image sensor 80 can be a monochrome image sensor, a color image sensor, infrared (IR), near IR, or ultraviolet (UV) sensor, etc. Regardless, the detector array 86 is adapted to generate and signal image information indicative of light transmitted thereon from the beamsplitter face 58.

The spacer 84 can assume a variety of forms, and in one embodiment is a filter. For example, in one embodiment, the spacer 84 is an anti-aliasing optical low pass filter capable of blurring the image for use with a Bayer CCD. To this end, the filter configuration is, in one embodiment, selected as a function of the selected image sensor 80. This filtering approach is highly applicable to configurations in which the image sensor 80 is a color image sensor. Alternatively, however, the spacer 84 can be selected/configured to have differing light filter characteristics. Even further, the spacer 84 can be a transparent, non-light filtering body that simply serves to space the detector array 86 a desired distance from the first side 50 of the beamsplitter assembly 30. In yet other embodiments, the spacer 84 can be eliminated entirely.

The second detector assembly 34 is similar to the first detector assembly 32, and includes an image sensor 100, a cover glass 102, and a spacer 104. The image sensor 100 includes a detector array 106 (referenced generally), a frame 108, and, in some embodiments, auxiliary components as previously described with respect to the image sensor 80. The image sensor 100 can take any of the forms previously described with respect to the image sensor 80 (e.g., a monochrome CCD chip, a color CCD chip, etc.). In one embodiment, the image sensors 80, 100 are similarly configured (e.g., the image sensors 80, 100 are both color image sensors). Alternatively, the image sensors 80, 100 can be adapted to sense and provide different image information (e.g., the image sensor 80 can be a color image sensor whereas the image sensor 100 is a monochrome image sensor, or vice-versa).

The spacer 104 can assume many of the forms previously described with respect to the spacer 84. Thus, the spacer 104 may or may not have a wavelength filtering attribute. Alternatively, in some embodiments, the spacer 104 is eliminated.

Regardless of an exact configuration, of the image sensors 80, 100 and the spacers 84, 104, the first and second detector assemblies 32, 34 are, in one embodiment, similarly assembled and permanently mounted to the beamsplitter assembly 30 such that a user (not shown) cannot readily move or remove the detector assemblies 32, 34 from the beamsplitter assembly 30. For example, in one embodiment, an adhesive or glue, preferably one that is optically clear, is employed to bond the cover glass 82, 102 to the corresponding spacer 84, 104 (where provided), as well as to bond the image sensor 80, 100 to the corresponding side 50, 52 of the beamsplitter assembly 30 (e.g., where provided, the spacer 84 is bonded to the first side 50, and the spacer 104 is bonded to the second side 52). In one embodiment, the optical adhesive is a UV curable adhesive of a type known to those skilled in the art. Alternatively, mechanical fasteners may be used to secure the cover glass 82, 102 to the corresponding spacer 84, 104. Regardless, once mounted to the beamsplitter assembly 30, the first and second detector assemblies 32, 34 are not readily movable relative to the beamsplitter assembly 30. With this configuration, then, the first detector assembly 32 is optically associated with the first side 50 of the beamsplitter assembly 30, whereas the second detector assembly 34 is optically associated with the second side 52.

The above-described permanent mounting of the detector assemblies 32, 34 to the beamsplitter assembly 30 is, in one embodiment, characterized by substantial optical alignment between the image sensors 80, 100 relative to the beamsplitter assembly 30, and in particular the beamsplitter face 58. By way of reference, the detector arrays 86, 106 include, in one embodiment, an array (e.g., multiple rows) of pixels. For purposes of explanation, FIG. 3 schematically illustrates a row of pixels 120 as part of the detector array 86 of the first detector assembly 32, and a row of pixels 122 of the detector array 106. It will be understood that in the two-dimensional view of FIG. 3, one or more additional rows of pixels can be provided but are not visible. Regardless, the row of pixels 120 includes pixels 120a, 120b, 120c, whereas the row of pixels 122 includes pixels 122a, 122b, 122c. Upon assembly to the beamsplitter assembly 30, a corresponding relationship is established between individual ones of these pixels 120a-120c, 122a-122c. For example, the image sensors 80, 100 are arranged relative to the beamsplitter face 58 such that the pixel 120a is substantially optically aligned with the pixel 122a, the pixel 120b is substantially optically aligned with the pixel 122b, etc. That is to say, relative a plane defined by an angle established by the beamsplitter face 58, the corresponding pixel pairs (e.g., the pixel pair 120a, 122a; the pixel pair 120b, 122b; etc.) have substantially identical or aligned x, y coordinates, such that the pixel pairs are substantially optically aligned in terms of translation and rotation relative to the beamsplitter face 58. With this in mind, where one of the image sensors 80 or 100 requires the use of a filter and the other does not (e.g., where useful operation of the image sensor 80 requires that the spacer 84 be an optical low pass filter, while useful operation of the image sensor 100 can be achieved without filtering incoming light), the “dummy filter” configuration mentioned above is employed to ensure optical alignment. That is to say, the filter (e.g., the spacer 84) will space the corresponding image sensor (e.g., the image sensor 80) a distance away from the corresponding beamsplitter assembly side (e.g., the side 50). In order to ensure that substantial optical alignment is achieved between the image sensors 80, 100, then, the transparent spacer (e.g., the spacer 104) is provided with the other image sensor (e.g., the image sensor 100) solely for the purpose of optical alignment.

In one embodiment, the phrase “substantially optically aligned” is characterized by sub-pixel alignment between corresponding pixels of a pixel pair. For example, in one embodiment, corresponding pixels of a pixel pair (e.g., the pixel pair 120a, 122a) are substantially optically aligned relative to the beamsplitter face 58 at ±0.75 μm, this translates to approximately 1/10th of a pixel if the CCD pixel size is about 7.4 μm. That is to say, any optical alignment offset (i.e., optical misalignment) between corresponding pixels of a pixel pair is no more than 0.1 multiplied by the pixel's major dimension in one embodiment. Other sub-pixel alignment offset values are also acceptable depending upon the application, and can be considered representative of “substantially optically aligned”. For example, in one embodiment, substantial optical alignment is characterized by the corresponding pixels or a pixel pair being aligned at +0.75 pixel. In another embodiment, substantial optical alignment is characterized by the corresponding pixels of a pixel pair being aligned at ±0.5 pixel; alternatively, and in another embodiment, corresponding pixels of a pixel pair are aligned at ±0.3 pixel. Mounting the first and second detector assemblies 32, 34 to the beamsplitter assembly 30 in a secure, and in some embodiments, permanent manner, helps to ensure that the substantial optical alignment attribute is permanently maintained and cannot be altered throughout the life of the camera module 26.

The above-described substantial alignment between the images sensors 80, 100 relative to the beamsplitter face 58 ensures that corresponding image information is generated by the detector arrays 86, 106 during use. For example, a light beam L enters the beamsplitter assembly 30 at the fourth side 56 and interfaces with the beamsplitter face 58. The beamsplitter face 58, in turn, divides the light beam L into a transmissive portion T and a reflective portion R. The transmissive portion T proceeds toward the second side 52 of the beamsplitter assembly 30, acting upon the pixel 122c. Simultaneously, the reflective portion R proceeds to the first side 50 and acts upon the pixel 120c of the first detector assembly 32. Thus, due to the substantial optical alignment of the image sensors 80, 100 relative to the beamsplitter face 58, the camera module 26 is capable of ensuring that image information generated at or by the pixel 120c of the first detector assembly 32 directly corresponds with image information generated at or by the pixel 122c of the second detector assembly 34. This substantial optical alignment is provided for all corresponding pixel pairs such that a signaled output from the image sensor 80 of the first detector assembly 32 corresponds with, or is interchangeable with, a signaled output from the image sensor 100 of the second detector assembly 34.

In some embodiments, a certain amount or percent of light is “lost” in the beamsplitter assembly 30. To eliminate this lost light, a photon motel 130 or beam dump is provided in some embodiments and is mounted to the third side 54 of the beamsplitter assembly 30. In one embodiment, the photon motel 130 is a two-walled device, where the first wall is a highly efficient light absorbing and controlled reflecting glass surface and the second wall is a highly efficient light absorbing surface optimally positioned to receive the light reflected from the first wall. For example, the first wall can be a piece of highly polished, light absorbing glass that eliminates significant amounts of the light received thereon, while the remaining light is reflected in a controlled manner but not scattered. The reflected light is directed toward the second wall that is a flat black coating surface where significant amounts of the light reflected from the first wall is absorbed. Alternatively, other light absorbing configurations can be provided. Even further, the photon motel 130 can be eliminated.

Returning to FIG. 2, the assembled beamsplitter, first detector, and second detector assemblies 30-34 are maintained within the housing 36 (shown schematically). The housing 36 can assume a variety of forms, and is, in one embodiment, adapted to facilitate assembly (and disassembly) of the camera module 26 relative to an inspection system. For example, one or both of the frames 88, 108 of the detector assemblies 32, 34 can be secured to an interior of the housing 36. Regardless, in one embodiment, the housing 36 includes a floor 140 defining an aperture 142 (shown generally) through which light can enter the housing 36 and be received or collected by the beamsplitter assembly 30.

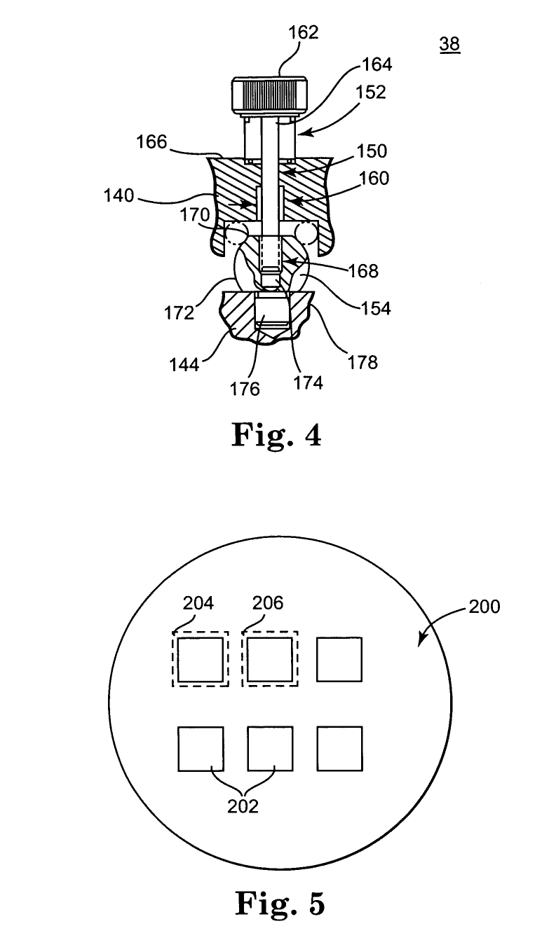

The mounting devices 38 facilitate precise positioning of the housing 36, and thus of the beamsplitter assembly 30, relative to an inspection system sample support. For example, and with reference to FIG. 4, in one embodiment, each of the mounting devices 38 is a pin assembly adapted to position the floor 140 at a known distance relative to an inspection system base 144 otherwise used to support a sample (not shown) to be inspected. With this in mind, and in one embodiment, the pin assembly 38 includes a pin 150, a compression spring 152, and a spacing body 154. The pin 150 is threadably secured within a bore 160 formed by the floor 140. A grasping body 162 is provided at a proximal end 164 of the pin 150, and is, in one embodiment, knurled. The compression spring 152 is coaxially disposed about the pin 150, and is sized to bear against the grasping body 162. Upon final assembly, an opposite side of the compression spring 152 nests against the floor 140, thus biasing the grasping body 162 away from an upper surface 166 of the floor 140. A distal side 168 of the pin 150 is slidably and coaxially received within the spacing body 154 that, in one embodiment, is a stainless steel ball. The spacing body 154 defines opposing, first and second sides 170, 172 that establish a desired spacing between the floor 140 and the base 144 upon final assembly as described below. Finally, a distal end 174 of the pin 150 is configured to threadably engage a collet 176 otherwise mounted within a passage 178 formed in the base 144.

With the above construction, the floor 140 is mounted to the base 144 by first aligning the pin 150 with the passage 178. The pin 150 is then rotated (e.g., via the grasping body 162) that in turn causes the pin 150 to extend into the passage 178 and threadably engage the collet 176. Rotation of the pin 150 continues until the floor 140 bears against the first side 170 of the spacing body 154 (with the second side 172 nesting against the base 144). The compression spring 152 prevents the pin 150 from being overtly extended into the passage 178. Conversely, the spacing body 154 dictates that a desired spacing between the floor 140 and the base 144 is achieved in a manner that avoids direct contact between the floor 140 and the base 144. To this end, a gasket 180 or similar body can be provided that promotes a more gradual interface between the floor 140 and the spacing body 154.

In one embodiment, and returning to FIG. 2, three of the mounting devices 38 are provided, being equidistantaly spaced relative to a circumference defined by the aperture 142. Alternatively, any other number of mounting devices 38 can be provided, and a wide variety of other mounting techniques employed. In alternative embodiments, the camera module 26 can be permanently mounted within an inspection system, such that one or both of the housing 36 and/or the mounting device 38 can be eliminated.

Regardless of whether the housing 36 and/or the mounting device 38 are provided, the camera module 26 is highly useful for performing rapid inspections, viewing, reconnaissance, and/or surveillance as part of the optical inspection system 20 shown in FIG. 1. To this end, the light source 22 and the controller 24 can assume many acceptable forms known in the art applicable to performing a desired inspection, such as inspecting a semiconductor wafer. Thus, for example, the light source 22 can be any source of light that provides sufficient light to illuminate the sample surface A and the light source 22 can be positioned relative to the sample B in any position so long as it provides the necessary light to the sample surface A to be viewed, inspected, or otherwise optically observed. Examples of the light source 22 include, but are not limited to, white light sources such as halogen or arc lights, lasers, light emitting diodes (LEDs) including white LEDs, or any of the various colored LEDs, fluorescent lights, natural light sources, or any other type of light source.

The controller 24 includes a microprocessor 28 programmed to effectuate performance of a desired inspection routine. While the controller 24, and in particular the microprocessor 28, is shown in FIG. 1 as being a component apart from the camera module 26, in alternative embodiments, the camera module 26 includes a separate microprocessor adapted to effectuate performance of one or more inspection routines (or portions thereof) made available by the camera module 26. That is to say, where the camera module 26 is separately assembled to the inspection system 20, the processor associated with the camera module 26 can be pre-programmed to interface with the controller 24 otherwise permanently provided with the inspection system 20 to perform inspection routines as well as, in alternative embodiments, a normalization procedure described below. Alternatively, the controller 24 can be pre-loaded with the appropriate inspection and/or normalization routines, or the camera module 26 can include appropriate software to be loaded onto the controller 24.

The facilitate a better understanding of the improved inspection capabilities provided by the camera module 26 of the present invention, reference is made to FIG. 5 in which a semiconductor wafer 200 is schematically illustrated. The semiconductor wafer 200 includes a plurality of semiconductor die 202 at a various stage of manufacture. At certain points in the manufacturing cycle, it is desirable to inspect the die 202, such as with the inspection system 20 (FIG. 1). To this end, the system 20 is adapted to optically inspect the die 202 by examining images obtained via the camera module 26. With this in mind, the wafer 200 is typically sized such that more than a single image obtained by the camera module 26 is required to properly inspect all of the die 202. That is to say, the camera module 26, and in particular, the images sensors 80, 100 (FIG. 3) has practical physical limitations whereby images must be obtained at multiple sites along the wafer 200. With this in mind, FIG. 5 illustrates one possible site 204 in phantom lines that can otherwise be defined by the camera module 26. As used throughout the specification, the term “site” is in reference to a portion of the sample surface A (FIG. 1) capable of being imaged by the camera module 26. Thus, to fully inspect the wafer 200, an image associated with the site 204 is obtained and reviewed, followed by obtaining and reviewing an image of an adjacent, second site 206, etc. Notably, while FIG. 5 illustrates each of the sites 204, 206 as encompassing an individual one of the die 202, depending upon a configuration of the wafer 200 and/or the camera module 26, an individual site may include multiple ones of the die 202, or multiple sites may be required to image/review a single die 202.

With the above explanation in mind, and with continued reference to FIGS. 1 and 5, one method of inspecting the sample surface A (e.g., the wafer 200) using the camera module 26 includes optically positioning the camera module 26 over the sample surface A, thus defining an image site of the sample surface A (e.g., the site 204 of FIG. 5). The light source 22 is activated to illuminate the sample surface A, with light reflecting from the sample surface A, and in particular from the site 204 being imaged, being collected by the camera module 26. In particular, and with additional reference to FIG. 3, light reflecting from the site 204 to be imaged progresses through the beamsplitter assembly 30 and interacts with the beamsplitter face 58 as previously described (e.g., split into the transmissive portion T and the reflective portion R). The so-divided light can then be processed by one or both of the detector assemblies 32 and/or 34 when prompted by the controller 24 (as described below) to generate image information that is signaled to the controller 24. The controller 24, in turn, generates an image of the site 204 (“site image”), and then reviews the site image to determine whether the site 204 is acceptable. For example, the site image can be compared with a model image or map (e.g., a template), with this comparison being indicative of the site 204 being acceptable or rejected. Alternatively, the site image can be reviewed or analyzed by the controller 24 (or other device) in a wide variety of other fashions to determine whether the site 204 is acceptable. This process is then repeated for a remainder of the sample surface A (e.g., the wafer 200) for all other sites of interest.

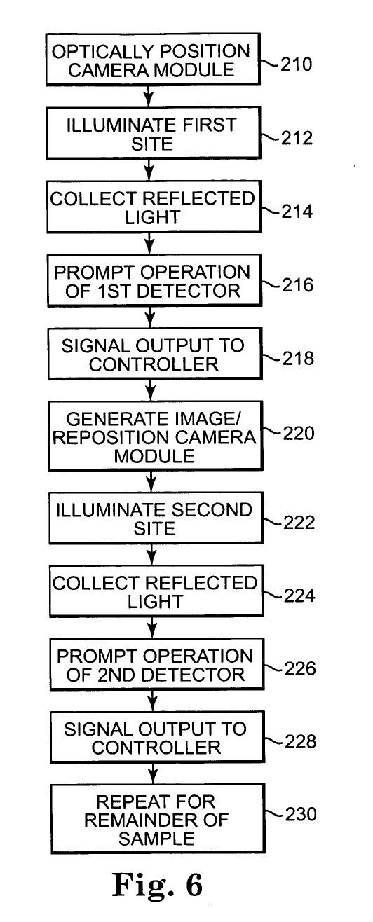

Because the camera module 26 is configured such that the detector assemblies 32, 34 obtain (or can be corrected or normalized to obtain as described below) virtually identical images, the camera module 26 can more rapidly perform the inspection process in a variety of manners. For example, and with reference to the flow diagram of FIG. 6, the controller 24 can operate the detector assemblies 32, 34 in an alternating fashion. Beginning at step 210, the camera module 26 is optically positioned over a first site. At step 212, the first site is illuminated (continuously or with a strobe-type illuminator), with light reflected from the first site being collected by the camera module 26 at step 214. The controller 24 prompts operation of the first detector assembly 32 to obtain and generate image information corresponding with light received by the camera module 26 from the first site at step 216.

The image information output is signaled to the controller 24 at step 218 for subsequent processing by the controller 24 to generate an image of the first site. Upon receiving the signaled image information and/or while the first detector assembly is generating the image information, the controller 24 prompts the inspection system 20 to optically position the camera module 26 over a second site (e.g., moving the sample A relative to the camera module 26, or vice-versa). This simultaneous or near simultaneous processing of image information by the controller 24 and/or first detector assembly 32 and movement to the second site is indicated at step 220. The second site is illuminated at step 222, with light reflected from the second site being collected by the camera module 26 at step 224. The controller 24, at step 226, prompts the second detector assembly 34 to obtain and generate image information associated with light received from the second site, with this information being signaled to the controller 24 at step 228. The controller 24 generates an image of the second site based upon this outputted image information while simultaneously initiating optical positioning of the camera module 26 over a third site, followed by illumination of the third site and prompting operation of the first detector assembly 32 to obtain image information associated with light reflected from the third site at step 230. This back-and-forth operation of the first and second detector assemblies 32, 34 to obtain site image information on an alternating basis obviates the time delay inherent to operation of the corresponding image sensors 80, 100. That is to say, while the first detector assembly 32 is processing received information (and/or while the controller 24 is processing signaled information from the first detector assembly 32 to generate a corresponding site image), the second detector assembly 34 is imaging a second site, etc. Once images have been generated for all sites for which all inspection is desired, the controller 24 reviews the images to determine whether defects in the sample surface A exist, as previously described.

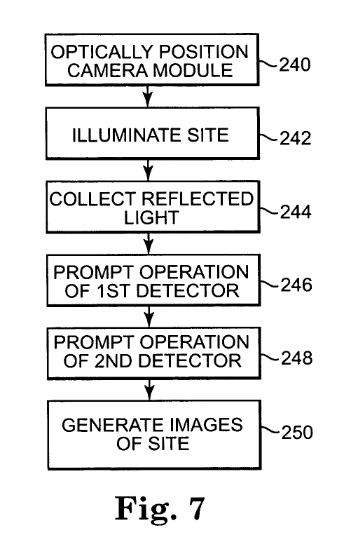

In an alternative embodiment, the camera module 26 is operated to facilitate simultaneous, or nearly simultaneous, inspection of a single site for differing image characteristics. That is to say, the camera module 26 can be operated such that the first and second detector assemblies 32, 34 acquire the same image and work in parallel to capture different optical characteristics. For example, and with reference to the flow diagram of FIG. 7, the camera module 26 is optically positioned over a site to be inspected at step 240. The site is illuminated at 242, with light reflected therefrom being collected at the camera module 26 at step 244. The controller 24, at step 246, prompts the first detector assembly 32 to obtain image information of the first site, followed by prompting of the second detector assembly 34 at step 248 (e.g., step 248 occurs within milliseconds of step 246). Outputted image information signaled from the first and second detector assemblies 32, 34 is signaled to the controller 24 to generate images for inspection at step 250. Thus, for example, the first detector assembly 32 can be configured to provide brightfield image information and the second detector assembly 34 configured to provide darkfield image information, thus enabling the controller 24 to virtually simultaneously generate and review a brightfield image and a darkfield image of the same site. A wide variety of other, simultaneously obtained image information can also be obtained, depending upon the type of detector arrays employed.

In one embodiment, an ability of the inspection system 20 to interchangeably rely upon and review image information from the first and second detector assemblies 32, 34 is premised upon the image sensors 80, 100 providing virtually identically or directly correlated image information. It is recognized, however, that in certain instances, the outputted signal for a given light intensity will vary for individual pixels. Thus, for example, optically aligned pixels of a pixel pair (e.g., the pixel pair 120a, 122a of FIG. 3) will consistently output a different intensity in response to the same received light input. In one embodiment, a calibration or normalization routine is implemented prior to inspection to correlate pixel intensity for reach optically aligned pixel pair. For example, in one embodiment, a known test or sample image is illuminated, and corresponding mean image information is obtained from each of the detector assemblies 32, 34. The so-obtained mean images are then compared on a pixel-by-pixel basis to generate a calibration factor for each pixel for at least one of the two detector assemblies 30 and/or 32.

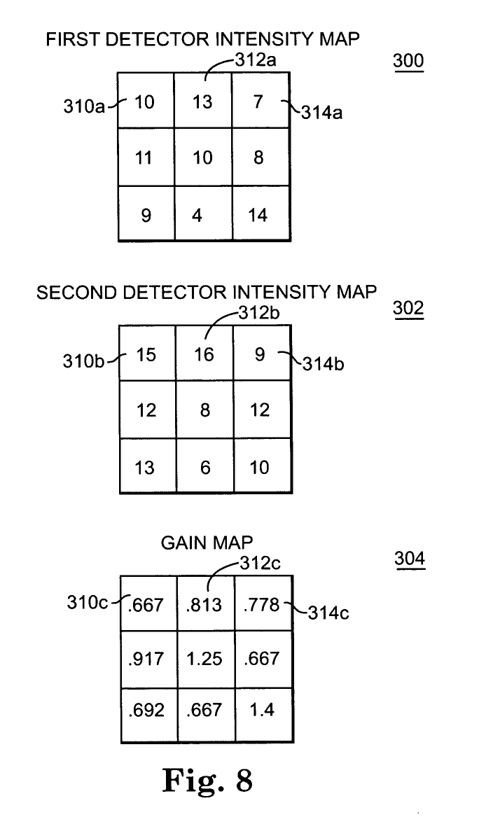

For example, in one embodiment, the first detector assembly 32 can be designated as the “control” image sensor, based upon which inspection routines are performed (e.g., compared with an “acceptable” image model map). Output information from the image sensor 100 of the second detector assembly 34 is then “normalized” pursuant to the calibration factor before comparing site image resulting from the second detector assembly 34 image information with the “acceptable” model map. To establish the calibration factor for each pixel associated with the image sensor 100 of the second detector assembly 34, in one embodiment an intensity map is generated for each pixel of the image sensors 80, 100, and then compared with one another to generate a gain map for “equalizing” output from the second detector assembly 34 with the first detector assembly 32. For example, FIG. 8 illustrates an intensity map 300 associated with the image sensor 80 of the first detector assembly 32 and an intensity sensor map 302 associated with the image sensor 100 of the second detector assembly 34 following imaging of a test or known image. For ease of illustration, the intensity maps 300, 302 are indicative of the image sensors 80, 100 each consisting of a 3×3 pixel array. A described above, the camera module 26 (FIG. 1) is configured such that individual pairs of substantially optically aligned pixels are defined (with corresponding pixel pairs being identified by like numbers in FIG. 8, including, for example, a first pixel pair 310a, 310b; a second pixel pair 312a, 312b; etc.).

A gain map 304 can be established based upon a ratio of individual pixel intensities of the intensity maps 300, 302. For example, in one embodiment, the intensity map 300 reflects that a grey level intensity of 10 (on a scale of 0 to 255) was measured at the first pixel 310a of the image sensor 80. The corresponding first pixel 310b grey level intensity measurement of 15 is shown in the intensity map 302. A correction factor of 0.667 is then calculated based upon a ratio of the first pixels 310a, 310b intensity measurements, and is shown in the gain map 304 at 310c (i.e., ratio of 10/15). A similar ratio or multiplier is established for each pixel of the second detector image sensor 100 based upon reference to the intensity map 300 established for the first detector image sensor 80. During use, then, intensity readings from each pixel of the second detector image sensor 100 are then multiplied by the corresponding gain map ratio to normalize output from the second detector assembly 34 with the first detector assembly 32. In this manner, then, a single model can be employed to assess/inspect for defects regardless of whether the image information used to generate the reviewed image comes from either of the detector assemblies 32 or 34. Alternatively, independent model maps can be provided for each of the detector assemblies 32 and 34, such that calibration or normalization of outputs from the first and second detector assemblies need not be performed. It should be noted that in creating gain maps for correlating respective image sensors, correction factors in addition to the ratio or multiplier described above may be used. For example, in some embodiments an offset, positive or negative, may be used in conjunction with a ratio or multiplier or lieu of a ratio or multiplier. Furthermore, gain maps may be stored and implemented by the controller 24 or may be incorporated directly into the structure of the sensors themselves.

Although the present invention has been described with reference to preferred embodiments, workers skilled in the art will recognize that changes can be made in form and detail without departing from the spirit and scope of the present invention. For example, while the camera module has been described as having two detector arrays, in other embodiments, three or more detector arrays (or chips) can be provided. Similarly, multiple beam splitters can be employed.

What is claimed is:

1. A camera module for use in an optical inspection system, the camera module comprising:
a beamsplitter assembly defining orthogonally arranged first and second sides optically separated by a beam splitter face;
a first detector assembly including a detector array for sensing an image and optically associated with the first side of the beamsplitter assembly; and
a second detector assembly including a detector array for sensing an image and optically associated with the second side of the beamsplitter assembly;
wherein the detector arrays of the first and second detector assemblies are substantially optically aligned relative to the beamsplitter assembly.

2. The camera module of claim 1, wherein the detector arrays of the first and second detector assemblies are substantially optically aligned relative to the beamsplitter face.

3. The camera module of claim 2, wherein the detector arrays each include an array of pixels, and further wherein respective ones of the array of pixels of the first detector assembly are substantially optically aligned with corresponding ones of the array of pixels of the second detector assembly.

4. The camera module of claim 3, wherein the substantially optically aligned relationship is characterized by sub-pixel alignment.

5. The camera module of claim 4, wherein x, y coordinates of corresponding pixels relative to the beamsplitter face are substantially optically aligned in terms of translation and rotation relative to the beamsplitter face.

6. The camera module of claim 1, wherein the first and second detector assemblies are permanently mounted to the beamsplitter assembly.

7. The camera module of claim 1, wherein the beamsplitter assembly includes a first prism defining the first side and a second prism defining the second side.

8. The camera module of claim 7, wherein the beamsplitter face is formed at an interface between the first and second prisms.

9. The camera module of claim 8, wherein the first and second prisms are right angle prisms, the beamsplitter face being formed on the first prism.

10. The camera module of claim 1, wherein the first detector assembly includes a filter.

11. The camera module of claim 10, wherein the detector array of the first detector assembly is attached to the filter, and the filter is attached to the first side of the beamsplitter assembly.

12. The camera module of claim 11, wherein the detector array of the first detector assembly is bonded to the filter with an optical adhesive.

13. The camera module of claim 10, wherein the filter is an optical low pass filter.

14. The camera module of claim 1, wherein the detector arrays are CCD chips.

15. The camera module of claim 14, wherein one of the CCD chips is a monochrome device and an other of the CCD chips is a color device.

16. The camera module of claim 14, wherein the CCD chips are both either monochrome or color devices.

17. The camera module of claim 1, wherein the detector arrays are CMOS chips.

18. The camera module of claim 17, wherein one of the CMOS chips is a monochrome device and an other of the CMOS chips is a color device.

19. The camera module of claim 17, wherein the CMOS chips are both either monochrome or color devices.

20. The camera module of claim 1, further comprising:
a photon motel associated with the beamsplitter assembly apart from the first and second sides.

21. The camera module of claim 1, wherein the first detector assembly is bonded to the first side with an optical adhesive and the second detector assembly is bonded to the second side with an optical adhesive.

22. The camera module of claim 1, further comprising:
a housing maintaining the beamsplitter assembly and the detector assemblies.

23. The camera module of claim 1, further comprising:
a mounting device associated with the housing and configured to selectively mount the camera module to an inspection device.

24. An optical inspection system for inspecting a surface of a sample, the system comprising:
a light source for illuminating a surface of a sample;
a camera module comprising:
a beamsplitter assembly defining orthogonally arranged first and second sides optically separated by a beamsplitter face,
a first detector assembly including a detector array and optically associated with the first side of the beamsplitter assembly,
a second detector array including a detector array and optically associated with the second side of the beamsplitter assembly,
wherein the detector arrays of the first and second detector assemblies are substantially optically aligned relative to the beamsplitter assembly; and
a controller electronically coupled to the camera module, the controller adapted to:
process image information signaled from the first and second detector assemblies, and
generate an image of at least one site on the sample surface based upon the signaled information.

25. The system of claim 24, wherein the controller is further adapted to perform an inspection routine based upon images generated from the first and second detector assembly image information.

26. The system of claim 25, wherein the controller is further adapted to:
cause the camera module to be optically positioned over a first site of the sample surface;
prompt the first detector assembly to obtain image information relating to the first site;
prompt the second detector assembly to obtain image information relating to the first site;
wherein the first and second detector assemblies obtain discrete image information.

27. The system of claim 25, wherein the controller is further adapted to:
cause the camera module to be optically positioned over a first site of the sample surface;
prompt the first detector assembly to obtain image information relating to the first site;
cause the camera module to be optically positioned over a second site of the sample surface while processing first site image information signaled from the first detector assembly; and
prompt the second detector assembly to obtain image information relating to the second site.

28. The system of claim 24, wherein the controller is further adapted to:
correlate signaled image information from the second detector assembly with signaled information from the first detector assembly.

29. The system of claim 28, wherein the controller is further adapted to:
generate a gain map indicative of a correlation between outputs of the first and second detector assemblies.

30. The system of claim 29, wherein the controller is further adapted to:
generate a first detector array mean intensity pixel map based upon reference to a known image;
generate a second detector assembly mean intensity pixel map based upon reference to the known image; and
compare the mean intensity pixel maps to generate the gain map.

31. A method of optically inspecting a surface of a sample, the method comprising:
providing a camera module including:
a beamsplitter assembly defining orthogonally arranged first and second sides optically separated by a beamsplitter face,
a first detector assembly including a detector array for sensing an image and optically associated with the first side of the beamsplitter assembly,
a second detector assembly including a detector array for sensing an image and optically associated with the second side of the beamsplitter assembly,
wherein the detector arrays of the first and second detector assemblies are substantially optically aligned relative to the beamsplitter assembly;
optically positioning the camera module over a sample surface;
illuminating a first site on the surface;
collecting reflected light from the first site by the camera module;
prompting the first detector assembly to generate first site image information;
processing the first site image information to generate a first site image; and
determining whether the first site is acceptable based upon reference to the first site image.

32. The method of claim 31, further comprising:
prompting the second detector assembly to generate first site image information;
processing the first site image information from the second detector assembly to generate a second first site image; and
determining whether the first side is acceptable based upon reference to the second first site image.

33. The method of claim 31, further comprising:
optically positioning the camera module over a second site of the sample surface while processing the first site image information from the first detector assembly;
prompting the second detector assembly to generate second site image information;
processing the second site image information to generate a second site image; and
determining whether the second site is acceptable based upon reference to the second site image.

34. The method of claim 31, further comprising:
correlating outputs from the first and second detector assemblies.

35. The method of claim 34, wherein correlating output includes:
deriving a gain ratio for each corresponding pixel pair of the detector assemblies.

36. The method of claim 35, further comprising:
receiving image information from the second detector assembly; and
establishing an image associated with the second detector assembly based upon the received image information and the gain ratios.

37. A method of optically inspecting a surveillance site, the method comprising:
providing a camera module including:
a beamsplitter assembly defining orthogonally arranged first and second sides optically separated by a beamsplitter face,
a first detector assembly including a detector array for sensing an image and optically associated with the first side of the beamsplitter assembly,
a second detector assembly including a detector array for sensing an image and optically associated with the second side of the beamsplitter assembly,
wherein the detector arrays of the first and second detector assemblies are substantially optically aligned relative to the beamsplitter assembly;
optically positioning the camera module to receive light from a chosen surveillance site;
collecting light from the surveillance site by the camera module;
prompting the first detector assembly to generate first surveillance site image information;
processing the first site image information to generate a first surveillance site image;
prompting the second detector assembly to generate second surveillance site image information simultaneous with the processing of the first site image information; and,
processing the second site image information to generate a second surveillance site image, the first detector assembly being prompted to generate subsequent first surveillance site image information simultaneous with the processing of the second site image information.

38. The method of optically inspecting a surveillance site of claim 37 wherein at least one of the first and second detector assemblies of the camera module is sensitive to UV radiation.

39. The method of optically inspecting a surveillance site of claim 37 wherein the camera module is moveable with respect to the surveillance site.
